(19) United States
(12) Patent Application Publication
(10) Pub. No.: US 2018/0262878 A1
(43) Pub. Date: Sep. 13, 2018

(54) ACCOUNT PUSHING METHOD AND APPARATUS, AND COMPUTER STORAGE MEDIUM

(71) Applicant: TENCENT TECHNOLOGY (SHENZHEN) COMPANY LIMITED, Shenzhen (CN)

(72) Inventors: Wenxiao Zheng, Guangdong (CN); Xinqi Liu, Guangdong (CN)

(73) Assignee: TENCENT TECHNOLOGY (SHENZHEN) COMPANY LIMITED, Shenzhen (CN)

(21) Appl. No.: 15/974,852

(22) Filed: May 9, 2018

Related U.S. Application Data
(63) Continuation of application No. PCT/CN2017/083735, filed on May 10, 2017.

(30) Foreign Application Priority Data
May 10, 2016 (CN) 2016103058554

(51) Int. Cl. H04W 4/021; H04W 4/21; H04L 29/08

(52) U.S. Cl. CPC H04W 4/022; H04L 67/306; H04L 67/26; H04W 4/21

(57) ABSTRACT

A method and apparatus are provided. The method includes obtaining a current location of a terminal, and a set of accounts that are on a client running on the terminal that is logged into by a first account and that have an association relationship with the first account. A list of target public accounts that are operated in the current location are obtained. One or more push accounts are selected from the list of target public accounts, based on the set of accounts that are obtained, and the one or more push accounts are pushed to the first account.

### CROSS REFERENCE TO RELATED APPLICATIONS

This application is a continuation of International Patent Application No. PCT/CN2017/083735, filed on May 10, 2017, which claims priority from Chinese Patent Application No. 2016103058554, filed in the Chinese Patent Office on May 10, 2016, the disclosures of each of which are incorporated by reference herein in their entirety.

### BACKGROUND

### 1. Field

The present disclosure relates to the field of computers, and specifically, to an account pushing method and apparatus, and a computer storage medium.

### 2. Description of Related Art

Currently, many applications provide a service of pushing information based on a location. A common manner is that a user terminal actively initiates a push request based on a current location, and a server pushes information related to the current location to the user terminal, for example, pushes information about a merchant relatively close to the current location, so that a user directly goes to the merchant indicated by the information.

However, the information pushed in this manner is always displayed according to distances, but the information with a closest distance is not necessarily the information mostly required by the user. That is, when performed by using a related art account pushing method, pushing cannot be performed according to a real requirement of the user. Consequently, accuracy of a pushed account is relatively low, and the requirement of the user cannot be satisfied.

There is currently no effective solution to the foregoing problem.

### SUMMARY

It is an aspect to provide an account pushing method and apparatus, and a computer storage medium, to at least resolve the technical problem of relatively low accuracy of an account that is pushed by using an existing account pushing method.

According to an aspect of one or more exemplary embodiments, there is provided a method. The method includes obtaining a current location of a terminal, and a set of accounts that are on a client running on the terminal that is logged into by a first account and that have an association relationship with the first account. A list of target public accounts that are operated in the current location are obtained. One or more push accounts are selected from the list of target public accounts, based on the set of accounts that are obtained, and the one or more push accounts are pushed to the first account.

According to other aspects of one or more exemplary embodiments, there is provided an apparatus consistent with the method.

### BRIEF DESCRIPTION OF THE DRAWINGS

Various exemplary embodiments are described below with reference to the accompanying drawings, in which:

FIG. 1 is a schematic diagram of an application environment of an account pushing method according to an exemplary embodiment;

FIG. 2 is a flowchart of an account pushing method according to an exemplary embodiment;

FIG. 3 is a schematic diagram of using an account pushing method according to an exemplary embodiment;

FIG. 4 is a flowchart of another account pushing method according to an exemplary embodiment;

FIG. 5 is a schematic diagram of an account pushing apparatus according to an exemplary embodiment;

FIG. 6 is a schematic diagram of another account pushing apparatus according to an exemplary embodiment; and

FIG. 7 is a schematic diagram of an account pushing server according to an exemplary embodiment.

### DETAILED DESCRIPTION

To make a person skilled in the art understand the technical solutions in the present disclosure better, the following clearly and completely describes the technical solutions in the exemplary embodiments with reference to the accompanying drawings in which the exemplary embodiments are shown. The described exemplary embodiments are merely a part rather than all of the exemplary embodiments. All other exemplary embodiments obtained by a person of ordinary skill in the art based on the exemplary embodiments without creative efforts shall fall within the protection scope of the present disclosure and the appended claims.

It should be noted that in the specification, claims, and accompanying drawings of the present disclosure, the terms “first”, “second”, and the like are intended to distinguish similar objects but do not necessarily indicate a specific order or sequence. It should be understood that data used in this way is exchangeable in a proper case, so that the exemplary embodiments described herein of the present disclosure may be implemented in another order except those shown or described herein. Moreover, the terms “include”, “have” and any other variants mean to cover the non-exclusive inclusion, for example, a process, method, system, product, or device that includes a list of steps or units is not necessarily limited to those steps or units, but may include other steps or units not expressly listed or inherent to such a process, method, system, product, or device.

In the exemplary embodiments, a set of accounts that have an association relationship with the first account, and a current location of the terminal are obtained, and a client running on a terminal is logged in to by using a first account. A list of public accounts to be pushed to the client is determined in a first public account according to at least a second public account, first operation information, and second operation information, the first public account being a public account operated in the location, the second public account being a public account operated by a second account in the set of accounts in the location, the first operation information being operation information of an operation performed on the first public account, and the second operation information being operation information of an operation performed on the second public account. Therefore, the public account relatively associated with the first account used by the client running on the terminal is obtained based on the current location of the terminal, to obtain the list of public accounts whose locations and content and are both associated with the first account. That is, the pushed account satisfies the real requirement better by combining the public account operated in the current location of the terminal and the operation information of the operation, thereby improving a correlation between the pushed account and the account used by the client running on the terminal for login. An account is not blindly pushed according to distances, thereby ensuring the accuracy of account pushing, to overcome the problem in the related art technology that the accuracy of pushing the account according to distances is relatively low.

In addition, for an operator or a publisher of a public account, the utilization of an associated account is greatly improved by accurately pushing the associated account to the account used by the client for login, thereby expanding a serving range of the associated account.

### Exemplary Embodiment 1

In this exemplary embodiment, a public account that is pushed by using the foregoing account pushing method may be, but is not limited to, a public social network entity performing interaction on an information exchange platform.

It should be noted that, in this exemplary embodiment, the information exchange platform is a network architecture associating one user account with another user account by using a social relationship and/or common interest (or common benefit). Common communication between accounts may be implemented and some daily routines may be processed by using a client provided by the information exchange platform. Each user account may have a network identity used for being distinguished from another user account on the information exchange platform.

In addition, on the information exchange platform, different user accounts may establish a social relationship in a manner of mutual confirmation, for example, adding each other as a friend or following each other, and the manner is not limited thereto. After two user accounts establish a social relationship, the two users become social network contacts of each other. A group of user accounts may form a mutual social relationship in a manner of voluntary selection, thereby forming a social group, and the manner is not limited thereto. Each member account in the group is a social network contact of all other member accounts in the group.

Further, a public social network identifier (for example, a public account) may be established on the information exchange platform, and the public (for example, any user account on the information exchange platform) are allowed to communicate with the public social network identifier on the information exchange platform. The communication may be based on a unidirectional confirmation manner, and mutual confirmation between users is not required. For example, the user account may choose to subscribe a public social network identifier (for example, “follow” a public social network identity) message or release information, and become a social network contact of the public social network identifier in such a unidirectional confirmation manner. An owner of a public social network identity may further use another user account as a social network contact of the owner, where the another user account is a user account who has subscribed to a message of the owner or releases information.

Herein, each user account and each public social network identifier (for example, a public account) on the information exchange platform have a social network contact list for the user account and the public social network identifier to communicate with a user account or a public social network identifier (for example, a public account) in the list in a form of instant messaging. For example, user accounts in a social group may communicate with each other by using an interface provided by the information exchange platform, and user accounts may also communicate with each other by using an interface provided by the information exchange platform.

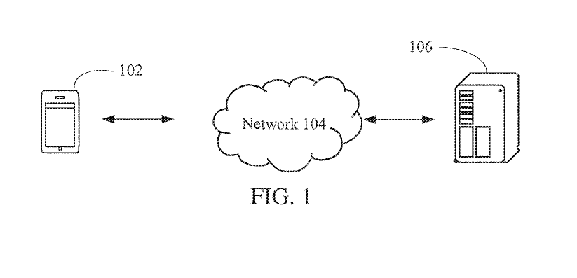

According to the exemplary embodiments, an exemplary embodiment of an account pushing method is provided. In this exemplary embodiment, the account pushing method may be applied to an application environment shown in FIG. 1 or other application environments. A server 106 obtains, by using a network 104, a set of accounts that are on a client running on a terminal 102 that is logged in to by using a first account and that have an association relationship with the first account, and a current location of the terminal 102. Then, the server 106 determines, in a first public account according to at least a second public account, first operation information, and second operation information, a list of public accounts to be pushed to the client running on the terminal 102, the first public account being a public account operated in the location, the second public account being a public account operated by a second account in the set of accounts in the location, the first operation information being operation information of an operation performed on the first public account, and the second operation information being operation information of an operation performed on the second public account. Therefore, the list of public accounts associated with the first account is determined by combining the first public account operated in the current location of the terminal, the corresponding first operation information, the second public account operated by the account in the set of accounts in the location, the corresponding second operation information, so that the list of public accounts used for being pushed to the first account used for logging in to the client is closer to a real requirement of the first account, thereby improving accuracy of account pushing.

In an implementation of this exemplary embodiment, the terminal may include, but not limited to, at least one of the following: a mobile phone, a tablet computer, a notebook computer, a desktop PC, or another intelligent device. The foregoing is merely an example, which is not limited in this exemplary embodiment. In this exemplary embodiment, the network may include, but is not limited to, at least one of the following: a wide area network, a metropolitan area network, or a local area network. The foregoing is merely an example, which is not limited in this exemplary embodiment.

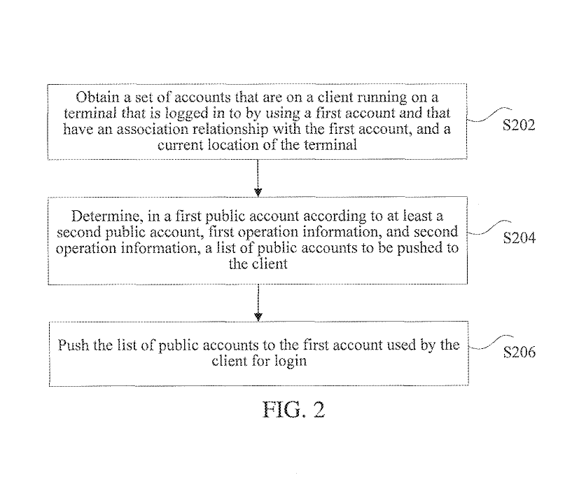

According to an exemplary embodiment, an account pushing method is provided. As shown in FIG. 2, the method includes the following steps:

S202. Obtain a set of accounts that are on a client running on a terminal that is logged in to by using a first account and that have an association relationship with the first account, and a current location of the terminal.

S204. Determine, in a first public account according to at least a second public account, first operation information, and second operation information, a list of public accounts to be pushed to the client, the first public account being a public account operated in the location, the second public account being a public account operated by a second account in the set of accounts in the location, the first operation information being operation information of an operation performed on the first public account, and the second operation information being operation information of an operation performed on the second public account.

S206. Push the list of public accounts to the first account used by the client for login.

In an implementation of this exemplary embodiment, the account pushing method may be applied to an account pushing process of different types of applications, for example, a game application, a communications application, and a video application. In this exemplary embodiment, the public account may be, but is not limited to, a public social network entity, for example, an account used by a particular group on an information exchange platform for exchanging content such as words, pictures, audio, or videos, for example, a public account such as a service number, a subscription, or a corporate account.

Specifically, the client running on the terminal logs in by using the first account. The set of accounts that are on the client and that have an association relationship with the first account, and the current location of the terminal are obtained. The list of public accounts to be pushed to the client is determined in the first public account according to at least the second public account, the first operation information, and the second operation information, the first public account being the public account operated in the location, the second public account being the public account operated by the second account in the set of accounts in the location, the first operation information being the operation information of an operation performed on the first public account, and the second operation information being the operation information of an operation performed on the second public account. Therefore, a more associated public account is pushed to the first account used by the client for login, thereby improving pushing accuracy.

It should be noted that, in this exemplary embodiment, the set of accounts that have an association relationship with the first account, and the current location of the terminal are obtained, where the client running on the terminal logs in by using the first account. The list of public accounts to be pushed to the client is determined in the first public account according to at least the second public account, the first operation information, and the second operation information, the first public account being the public account operated in the location, the second public account being the public account operated by the second account in the set of accounts in the location, the first operation information being the operation information of an operation performed on the first public account, and the second operation information being the operation information of an operation performed on the second public account. The list of public accounts is pushed to the first account used by the client for login. Therefore, the public account relatively associated with the first account used by the client running on the terminal is obtained based on the current location of the terminal, to obtain the list of public accounts whose locations and content are both associated with the first account. That is, the pushed account satisfies the real requirement better by combining the public account operated in the current location of the terminal and the operation information of the operation, thereby improving a correlation between the pushed account and the account used by the client for login running on the terminal. An account is not blindly pushed according to distances, thereby ensuring the accuracy of account pushing, to overcome the problem in the existing technology that the accuracy of pushing the account according to distances is relatively low. In addition, for an operator or a publisher of an account, the utilization of an associated account is greatly improved by accurately pushing the associated account to the account used by the client for login, thereby expanding a serving range of the associated account.

In an implementation of this exemplary embodiment, the set of accounts that have an association relationship with the first account may be, but is not limited to, user accounts used for exchanging content such as words, pictures, audio, and videos. The association relationship may include, but is not limited to, a member account (the second account) in the set of accounts is an account that is bound to the first account in advance, for example, one or more accounts in a friend list of the first account.

In an implementation of this exemplary embodiment, the operation may include, but is not limited to, at least one of the following: a session sharing operation, a space sharing operation, an account association operation, a searching operation, or an account login operation. The account association operation may include, but is not limited to, a subscription operation, a following operation, or the like. In addition, in this exemplary embodiment, the operation information may include, but is not limited to, an operation type and an operation quantity corresponding to the operation type.

It should be noted that, in this exemplary embodiment, the foregoing different operations may or have different priorities or a same priority. Different preset weights may be configured when the to-be-pushed list of public accounts is determined. This is not limited in this exemplary embodiment.

In an implementation of this exemplary embodiment, the determining, in a first public account according to at least a second public account, first operation information, and second operation information, a list of public accounts to be pushed to the client may be, but is not limited to, obtaining, from the first public account according to the first operation information, a target public account whose use frequency in the location is greater than a first predetermined threshold; and after searching the target public account for a public account matching the second public account, determining a correlation between the matching public account and the first account according to at least the second operation information, so as to obtain, according to the correlation, the list of public accounts for pushing.

It should be noted that, in this exemplary embodiment, the use frequency may be obtained by means of statistics collection by the server according to the public account operated by all accounts of the application client, or may be obtained in another manner. The target public account obtained according to the use frequency may be, but is not limited to, a superior public account obtained by analyzing a large amount of statistics data. That is, the superior public account is a public account that the public pay relatively much attention. Therefore, the superior public account is selected to serve as a candidate account (that is, the target public account) that is of the public account and that is used for pushing. A correlation between the superior public account and the first account is further determined by combining the second operation information and/or a time stamp, so as to accurately push the associated public account to the first account.

In an implementation of this exemplary embodiment, the list of public accounts may include, but is not limited to a group of public account sequences. An order of the sequences may be determined according to the correlation, or may be determined according to another factor.

In an implementation of this exemplary embodiment, the determining a correlation between the matching public account and the first account according to at least the second operation information may include, but is not limited to:

1) determining a first correlation between the matching public account and the first account according to an operation type indicated by the second operation information and an operation quantity corresponding to the operation type; and

2) obtaining a time stamp of the matching public account, to determine a second correlation between the matching public account and the first account.

A priority of the second correlation may be higher than a priority of the first correlation. That is, time validity comes first.

It should be noted that, in this exemplary embodiment, the server may obtain, according to the first correlation between the matching public account and the first account that is determined according to the second operation information, the list of public accounts for pushing; or may determine the second correlation between the matching public account and the first account by combining a time stamp of the matching public account and by using the time validity of the matching public account. Therefore, the public account associated with the first account obtained, and the list of public accounts for pushing is obtained, so that the pushed list of public accounts may satisfy the real requirement, thereby improving accuracy of account pushing.

In an implementation of this exemplary embodiment, when the public account matching the second public account is not found from the target public account, the list of public accounts may be determined in at least one of the following manner or in another manner:

1) obtaining a time stamp of the target public account, to determine a third correlation between the target public account and the first account, so as to determine the list of public accounts by using the third correlation; and

2) determining the list of public accounts according to use frequency.

It should be noted that, in this exemplary embodiment, when the public account matching the second public account is not found in the target public account, that is, when a friend account associated with the first account has not performed, in the location, any operation on the target public account (that is, a candidate account) obtained according to the first operation information, the third correlation between the target public account and the first account may be directly obtained by using the time stamp, to obtain, according to time validity of the target public account, the list of public accounts for pushing.

In an implementation of this exemplary embodiment, the obtaining the list of public accounts according to the correlations includes: obtaining first N public accounts according to values of the correlation, to obtain the list of public accounts. N is greater than or equal to 1. Therefore, the first N public accounts having a relatively large association are pushed to the first account according to the values of the correlations, so that the pushed public accounts further satisfy a requirement of a user.

In addition, in this exemplary embodiment, for a public account whose correlation cannot be obtained, an order, which is in the list of public accounts, of target public accounts that do not have the time stamp and that have not been operated by the second account in the set of accounts may be determined according to the use frequency or according to another factor. This is not limited in this exemplary embodiment.

In an implementation of this exemplary embodiment, the obtaining a current location of the terminal includes the following steps:

S1. Obtain a target location reported in real time by the terminal.

S2. Search for a preset location matching the target location.

S3. Use the preset location as the current location of the terminal when the preset location matching the target location is found, where a distance between the matching preset location and the target location is less than a second predetermined threshold.

It should be noted that, in this exemplary embodiment, the terminal constantly moves in an environment. The client running on the terminal may detect a change of the location of the terminal in real time, and report the detected target location, so that the server compares the target location with a preset location pre-divided by a system. When the target location reported by the terminal matches the preset location (that is, the preset location matching the target location is found), the preset location is used as the current location of the terminal, so as to obtain an operated public account and corresponding operation information according to the current location of the terminal.

In an implementation of this exemplary embodiment, the first public account and the second public account may be, but is not limited to, public accounts having a location tag. That is, in this exemplary embodiment, the public accounts having the location tag may be selected according to, but not limited to, registration information, service information, and the like of the public accounts. Further, the account pushing method provided in this exemplary embodiment may be performed on the public accounts having the location tag, to push the list of public accounts having the location tag to the first account of the client.

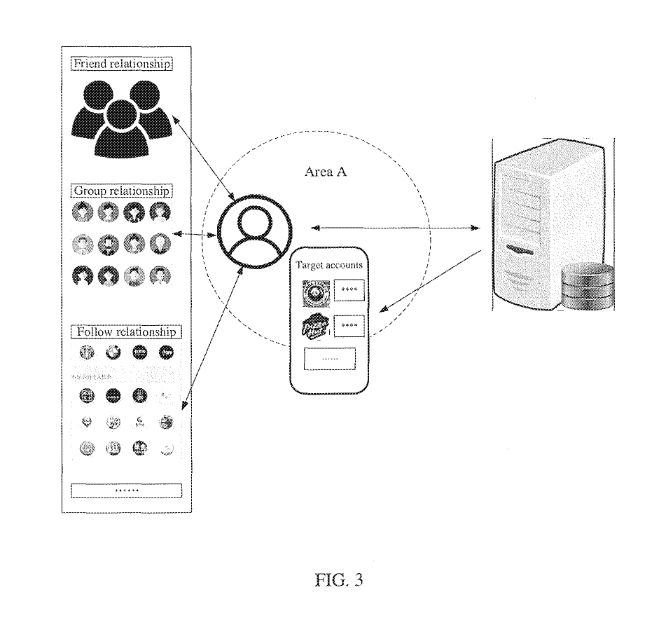

As shown in FIG. 3, for example, when in use, a user U1 is logged into a client (e.g., WeChat) and a recommendation function is enabled. If the user enters an area A, the user's location is obtained by one or more recommenders, e.g., a server or servers, in real-time. Additionally, when allowed by the user U1, the one or more recommenders search and obtain information of a set of accounts, e.g., public accounts and/or private accounts, that have an association relationship with the user U1. The set of accounts may correspond to a plurality of users U2, U3, U4, etc., and may include one or more accounts that correspond to the user U1. The one or more recommenders obtain a list of target public accounts that are operated in the current location. For example, if the area A includes various stores, restaurants, entertainments, etc., the list of target public accounts may list all of the public accounts belonging to the owners of the stores, restaurants, entertainments, etc. Different from the related art, in this exemplary embodiment, the one or more recommenders further analyze the association relationships between the user U1 and the plurality of users U2, U3, U4, etc., e.g., a friend relationship, a follow relationship, a group relationship, and/or a sharing relationship etc., and further analyze the frequency of interaction between the set of accounts and the target accounts, and obtain the current time, and so on. The one or more recommenders combine the analysis results and the current time to adjust the list of target public accounts based on the association relationships, the frequency of interaction, and/or the current time, to obtain one or more push accounts to be pushed. For example, if the current time is dinner time, and the analysis results show that some other friends (corresponding to one or more of the set of accounts) who have followed or visited or recommended one or more restaurants nearby, and the user U1 also follows an account for another restaurant, the one or more recommenders may adjust the list of target public accounts, by showing the public accounts relative to food first, and making the restaurant that the user U1 followed to be on top (e.g., a highest priority), and then the restaurants that the friends have followed or visited or recommended, etc. next (e.g., a second highest priority). As such, the user U1 may easily obtain the target public accounts as needed.

It is assumed that, as shown in Table 1, the first public account operated in the location includes ten public accounts. The operation that is indicated by the first operation information and that is performed on the first public account includes: a space sharing operation, a searching operation, and an account login operation. The corresponding operation quantities are shown in Table 1.

TABLE 1

| | First operation information | | |
|---|---|---|---|
| | Account login | Searching | Space sharing |
| First public account | operation | operation | operation |
| Public account ID-1 | 80,000 times | 90,000 times | 80,000 times |
| Public account ID-2 | 100,000 times | 80,000 times | 110,000 times |
| Public account ID-3 | 120,000 times | 90,000 times | 150,000 times |
| Public account ID-4 | 100,000 times | 120,000 times | 100,000 times |
| Public account ID-5 | 150,000 times | 110,000 times | 120,000 times |
| Public account ID-6 | 60,000 times | 100,000 times | 80,000 times |
| Public account ID-7 | 50,000 times | 120,000 times | 60,000 times |
| Public account ID-8 | 120,000 times | 100,000 times | 150,000 times |
| Public account ID-8 | 120,000 times | 100,000 times | 150,000 times |
| Public account ID-9 | 60,000 times | 150,000 times | 100,000 times |
| Public account ID-10 | 100,000 times | 80,000 times | 120,000 times |

Further, it is assumed that the second public account operated in the location includes five public accounts. The operation that is indicated by the second operation information and that is performed on the second public account includes: a space sharing operation, a searching operation, and an account login operation. The corresponding operation quantities are shown in Table 2. The slash represents that the operation is not performed.

TABLE 2

| | Second operation information | | |
|---|---|---|---|
| | Account login | Searching | Space sharing |
| Second public account | operation | operation | operation |
| Public account ID-1 | 10 times | | 6 times |
| Public account ID-3 | 8 times | 10 times | 12 times |
| Public account ID-8 | | 10 times | 12 times |
| Public account ID-10 | 10 times | 8 times | |
| Public account ID-11 | 10 times | | 12 times |

The list of public accounts to be pushed to the client is determined in the first public account according to at least the first operation information, the second operation information, and the second public account.

According to this exemplary embodiment provided in this application, the pushed account satisfies the real requirement better by combining the public account operated in the current location of the terminal and the operation information of the operation, thereby improving a correlation between the pushed account and the account used by the client running on the terminal for login. An account is not blindly pushed according to distances, thereby ensuring the accuracy of account pushing, to overcome the problem in the existing technology that the accuracy of pushing the account according to distances is relatively low. In addition, for an operator or a publisher of an account, the utilization of an associated account is greatly improved by accurately pushing the associated account to the account used by the client for login, thereby expanding a serving range of the associated account.

In some exemplary embodiments, the determining, in a first public account according to at least a second public account, first operation information, and second operation information, a list of public accounts to be pushed to the client may include the following steps:

S1. Obtain, from the first public account according to the first operation information, a target public account whose use frequency in the location is greater than a first predetermined threshold.

S2. Search the target public account for a public account matching the second public account.

S3. Determine a correlation between the matching public account and the first account according to at least the second operation information when the matching public account is found.

S4. Obtain the list of public accounts according to the correlation.

In an implementation of this exemplary embodiment, the first operation information may include, but is not limited to, an operation type of an operation performed on the first public account in the current location of the terminal and an operation quantity corresponding to the operation type. The operation may include at least one of the following: a session sharing operation, a space sharing operation, an account association operation, a searching operation, or an account login operation.

It should be noted that, in this exemplary embodiment, the foregoing different operations may or have different priorities or a same priority. Different preset weights may be configured when the to-be-pushed list of public accounts is determined, to obtain a corresponding correlation between the first public account and the first account. This is not limited in this exemplary embodiment.

In an implementation of this exemplary embodiment, before the obtaining, from the first public account according to the first operation information, a target public account whose use frequency in the location is greater than a first predetermined threshold, the method may further include: obtaining, according to the first operation information, an operation type of an operation performed on each first public account and an operation quantity corresponding to the operation type; and obtaining use frequency of each first public account in the location according to a second weight corresponding to the operation type and the operation quantity corresponding to the operation type. In this exemplary embodiment, the first public account operated in the location may include, but is not limited to, one or more public accounts and one or more public accounts of the second public account operated in the location.

For details, refer to the example shown in Table 1 for description. It is assumed that the operation that is indicated by the first operation information and that is performed on the first public account includes: an account login operation, a searching operation, and a space sharing operation, and corresponding weights are 0.2, 0.3, and 0.5. The corresponding use frequency may be shown in Table 3.

TABLE 3

| First public account | Use frequency |
|---|---|
| Public account ID-1 | 8.3 |
| Public account ID-2 | 9.9 |
| Public account ID-3 | 12.6 |
| Public account ID-4 | 10.6 |
| Public account ID-5 | 12.3 |
| Public account ID-6 | 8.2 |
| Public account ID-7 | 7.6 |
| Public account ID-8 | 12.9 |
| Public account ID-9 | 10.7 |
| Public account ID-10 | 10.4 |

It is assumed that the first predetermined threshold is 10. The target public account sequentially includes: public account ID-8, public account ID-3, public account ID-5, public account ID-9, public account ID-4, and public account ID-10.

Further, the public account matching the second public account in the target public account is searched with reference to Table 2. It may be obtained through comparison that the matching public account includes: public account ID-8, public account ID-3, and public account ID-10. Correlations between the matching public accounts and the first account are separately determined according to the second operation information, to obtain the list of public accounts according to the correlations. Therefore, the public account associated with the first account may be pushed to the first account of the client, to ensure accuracy of public account pushing, and improve the user experience.

It should be noted that, in this exemplary embodiment, the list of public accounts may include, but is not limited to, the matching public account, or may include another public account obtained according to another rule. The another rule may include, but is not limited to, time validity and use frequency. For example, it is assumed that it is preset that the list of public accounts may include five public accounts. In the foregoing example, the public account includes only three public accounts. Moreover, two public accounts may further be obtained according to the use frequency to serve as public accounts on the list of public accounts, for example, public account ID-5 and public account ID-9.

According to this exemplary embodiment provided in this application, the target public account whose use frequency is greater than the first predetermined threshold is selected from the first public account according to the first operation information, and, the target public account is searched for the public account matching the second public account, thereby determining the correlation between the public account and the first account according to at least the second operation information, to obtain the list of public accounts according to the correlation. That is, the public account associated with the first account is obtained by using the public account operated in the current location of the terminal and the operation information of the operation, thereby improving the correlation between a pushed account and an account used by the client running on the terminal for login, so that the pushed account satisfies a real requirement better, thereby further ensuring accuracy of account pushing. In addition, because the pushed account is accurate, the utilization of the pushed account is further improved.

In some exemplary embodiments, the determining a correlation between the matching public account and the first account according to at least the second operation information may include the following steps:

S1. Obtain, according to the second operation information, an operation type of an operation performed on the matching public account and an operation quantity corresponding to the operation type.

S2. Obtain a first correlation between the matching public account and the first account according to a first weight corresponding to the operation type.

In an implementation of this exemplary embodiment, the obtaining a first correlation between the matching public account and the first account according to a first weight corresponding to the operation type may include, but is not limited to: obtaining a weighted average between each matching public account and an operation quantity corresponding to the operation type, to serve as the first correlation between the matching public account and the first account.

A detailed description is given with reference to the following example. The obtaining a first correlation between the matching public account and the first account according to a first weight corresponding to the operation type may include obtaining the first correlation by the following formula:

$${S}_{j} = {\sum }_{i = 1}^{n} {a}_{i} {P}_{i} \qquad ( 1 )$$

where Sⱼ represents the first correlation between the j^{th} matching public account and the first account, Pᵢ represents an operation quantity corresponding to the i^{th} operation type, aᵢ represents a first weight corresponding to the i^{th} operation type, and n represents n operation types.

A description is given with reference to the example shown in Table 2. It is assumed that, with reference to Table 2, the public account that is found in the target public account and that matches the second public account includes: public account ID-8, public account ID-3, and public account ID-10. The operation that is indicated by the second operation information and that is performed on the second public account includes: an account login operation, a searching operation, and a space sharing operation, and corresponding weights are 0.2, 0.2, and 0.6. The corresponding first correlation may be shown in Table 4.

TABLE 4

| Matching public account | First correlation |
|---|---|
| Public account ID-3 | 8.4 |
| Public account ID-8 | 9.2 |
| Public account ID-10 | 3.6 |

That is, in this exemplary embodiment, public account ID-8, public account ID-3, and public account ID-10 may be sequentially pushed according to the foregoing first correlations. That is, in this exemplary embodiment, a public account that has been operated by a friend account of the first account is preferably selected from the list of public accounts. For example, a public account that is relatively frequently shared by the friend account of the first account and a public account that is followed by the friend account of the first account are preferably pushed. Different operations have different priorities and correspond to different first weights. An operation with a higher priority corresponds to a larger first weight. For example, a priority of the account login operation is lower than a priority of the space sharing operation, and corresponding weights are 0.2 and 0.6.

It should be noted that, in this exemplary embodiment, the list of public accounts may include, but is not limited to, the matching public account having the first correlation, or may include another public account obtained according to another rule. The another rule may include, but is not limited to, time validity and use frequency. For example, it is assumed that it is preset that the list of public accounts may include five public accounts. In this exemplary embodiment, in addition to three public accounts having the first correlation, the list of public accounts may further obtain two additional public accounts according to use frequency of the public accounts, to obtain all public accounts in the list of public accounts. Herein, the public accounts having the first correlation are sorted according to correlations, and the rest are sorted according to the use frequency. For example, according to the foregoing example, the list of public accounts that is obtained herein and that is pushed to the first account in the location may sequentially include: public account ID-8, public account ID-3, public account ID-10, public account ID-5, and public account ID-9.

According to this exemplary embodiment provided in this application, the operation type of an operation performed on the matching public account and the operation quantity corresponding to the operation type are obtained according to the second operation information, to obtain the first correlation between the matching public account and the first account according to the first weight corresponding to the operation type, thereby ensuring that the public account having a high association with the first account is pushed to a first client, to improve use efficiency of the public account.

In some exemplary embodiments, the determining the correlation between the matching public account and the first account according to the second operation information may include the following steps:

S1. Obtain a first time stamp of the matching public account.

S2. Obtain a second correlation between the matching public account and the first account according to the first time stamp, where a priority of the second correlation is higher than a priority of the first correlation.

In an implementation of this exemplary embodiment, the correlation between the public account and the first account may be obtained according to a time indicated by the time stamp of the public account, which is not limited in this exemplary embodiment. That is, the to-be-pushed list of public accounts is determined according to time validity. For example, during mealtime, a public account about food is preferably pushed. For example, during holidays, a public account about weather or transport is preferably pushed. The foregoing is merely an example, which is not limited in this exemplary embodiment.

For example, it is assumed that a current time is 19:00 on Saturday, and the first time stamp of the matching public account obtained in the foregoing example is shown in Table 5.

TABLE 5

| Matching public account | First time stamp |
|---|---|
| Public account ID-3 (a food public account) | 11:30-12:30 |
| | 17:00-19:00 |
| Public account ID-8 (a weather public account) | 9:00 |
| | 18:00 |
| Public account ID-10 (an airline public account) | Holidays 10:00 |

With reference to Table 5, it may be obtained, by comparing time, public account ID-3 (the food public account) and public account ID-10 (the airline public account) that have the second correlation. Further, with reference to the first correlation based on the second correlation, the list of public accounts: public account ID-3 (the food public account), public account ID-10 (the airline public account), and public account ID-8 (the weather public account) may be pushed to the first account logging in to the terminal in the location.

According to this exemplary embodiment provided in this application, the first time stamp of the matching public account is combined, to obtain the second correlation between the matching public account and the first account according to the first time stamp. The priority of the second correlation is higher than the first correlation. The to-be-pushed list of public accounts is determined with reference to the second correlation and the first correlation. That is, a public account associated with the first account is obtained from different dimensions, thereby obtaining the list of public accounts satisfying a requirement in multiple dimensions, to ensure accuracy of the pushed account, and further improve the use efficiency of the pushed account.

In some exemplary embodiments, after the searching the target public account for a public account matching the second public account, the method may further include the following steps:

S1. Obtain a second time stamp of the target public account when the matching public account is not found.

S2. Determine a third correlation between the target public account and the first account according to the second time stamp.

In an implementation of this exemplary embodiment, when the public account matching the second public account is not found in the target public account, the third correlation between the target public account and the first account may be directly obtained by using the second time stamp.

A detailed description is given with reference to the example shown in Table 1. Second time stamps of the ten public accounts shown in Table 1 may be directly obtained, and further, correlations between the ten public accounts and the first account are determined according to time validity of the time stamps. For a specific process, refer to the foregoing example, and details are not described in this exemplary embodiment again.

According to this exemplary embodiment provided in this application, the second time stamp of the target public account is obtained, to determine the third correlation between the target public account and the first account according to the second time stamp. In this way, the public account associated with the first account may be obtained from a time dimension when the public account matching the second public account is not found, thereby ensuring that an associated account is accurately pushed to the first account in the terminal in the location, to improve the accuracy of the pushed account, so that the pushed account satisfies the real requirement better.

In some exemplary embodiments, before the obtaining, from the first public account according to the first operation information, a target public account whose use frequency in the location is greater than a first predetermined threshold, the method may further include the following steps:

S1. Obtain, according to the first operation information, an operation type of an operation performed on each first public account and an operation quantity corresponding to the operation type.

S2. Obtain use frequency of each first public account in the location according to a second weight corresponding to the operation type and the operation quantity corresponding to the operation type.

In an implementation of this exemplary embodiment, the operation indicated by the first operation information and the operation indicated by the second operation information may be the same or may be different. When the indicated operations are the same, the first weight and the second weight may be set to different values or a same value according to different application scenarios, which is not limited in this exemplary embodiment.

For details, refer to the example shown in Table 1 for description. It is assumed that the operation that is indicated by the first operation information and that is performed on the first public account includes: an account login operation, a searching operation, and a space sharing operation, and corresponding weights are 0.2, 0.3, and 0.5.

Further, the use frequency of the first public account in the location may be obtained in the following manner according to the following formula or in another manner according to the second weight corresponding to the operation type and the operation quantity corresponding to the operation type:

$${P}_{t} = {\sum }_{i = 1}^{m} {b}_{i} {Q}_{i} \qquad ( 2 )$$

where Pₜ represents use frequency of the t^{th} first public account in the location, Qᵢ represents an operation quantity corresponding to the i^{th} operation type, bᵢ represents the second weight corresponding to the i^{th} operation type, and m represents m operation types.

In this exemplary embodiment, the use frequency of the first public account in the location shown in Table 3 may be obtained.

According to this exemplary embodiment provided in this application, the operation type of the operation performed on each first public account and the operation quantity corresponding to the operation type are obtained according to the first operation information; the use frequency of each first public account in the location is obtained according to the second weight corresponding to the operation type and the operation quantity corresponding to the operation type. In this way, the target public account is obtained from a large number of first public accounts, to narrow down the range of to-be-pushed public accounts, and improve the pushing efficiency. In addition, if the target public account whose use frequency is greater than the first predetermined threshold is selected from the first public account, a public account with relatively high quality, that is, the public account followed by a relative large number of users, may be selected, so that the user efficiency of the pushed public account is improved.

In some exemplary embodiments, the obtaining a current location of the terminal may include the following steps:

S1. Obtain a location reported in real time by the terminal.

S2. Search for a preset location matching the location reported by the terminal.

S3. Use the preset location as the current location of the terminal when the preset location matching the location reported by the terminal is found, where a distance between the matching preset location and the location reported by the terminal is less than a second predetermined threshold.

It should be noted that, in this exemplary embodiment, the terminal constantly moves in an environment. The client running on the terminal may detect a change of the location of the terminal in real time, and report the detected target location, so that the server compares the target location with a preset location pre-divided by a system. When the target location reported by the terminal matches the preset location (that is, the preset location matching the target location is found), the preset location is used as the current location of the terminal, so as to obtain an operated public account and corresponding operation information according to the current location of the terminal.

A detailed description is given with reference to the following example. It is assumed that it is obtained that the location reported by the terminal is A. It is obtained through searching that the location A is relatively close to a preset location A′ (a distance between the location A and the preset location A′ is less than the second predetermined threshold), and in this exemplary embodiment, the preset location A′ may or may not be used as the current location of the terminal. Therefore, public account operated in the preset location A′ and corresponding operation information are obtained.

According to this exemplary embodiment provided in this application, the target location reported by the terminal obtained in real time, and is compared with the preset location, to obtain the current location of the terminal used for obtaining the public account. Therefore, the current location of the terminal on which the client runs is passively obtained. The associated public account may be pushed in real time to the first account used by the client for login, without actively sending, on the client, a push request carrying location information of the current location of the terminal, thereby simplifying an account pushing operation, and improving the efficiency of account pushing.

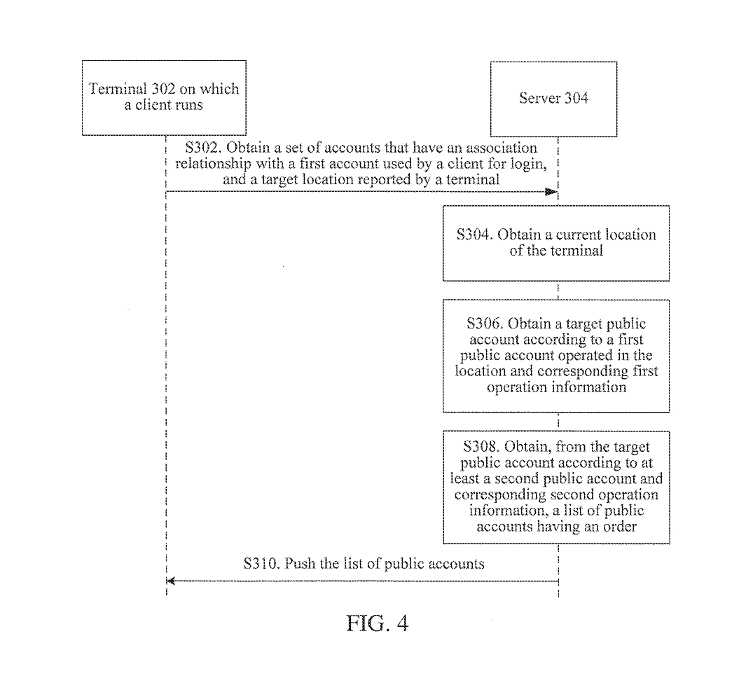

A detailed description is given with reference to steps S302 to S310 shown in FIG. 4. The client runs on a terminal 302. A server 304 obtains a set of accounts that have an association relationship with the first account used by the client for login, and the target location reported by the terminal 302 on which the client runs (S302). The server 304 obtains a current location of the terminal 302 (S304), for example according to a comparison result between the target location and the preset location. Further, the server 304 obtains the target public account according to the first public account operated in the location and the corresponding first operation information (S306). Then, the server 304 obtains, from the target public account according to at least the second public account and the corresponding second operation information, the list of public accounts having an order (S308), and pushes the list of public accounts to the terminal 302 on which the client logs in by using the first account runs (S310).

It should be noted that, for ease of description, the foregoing method exemplary embodiments are described as a series of action combinations. However, a person skilled in the art should understand that the present disclosure is not limited to the described sequence of the actions, because some steps may be performed in another sequence or performed at the same time according to the present disclosure. In addition, a person skilled in the art should also know that all the exemplary embodiments described in this specification are preferred exemplary embodiments, and the related actions and modules are not necessarily required in the present disclosure.

Through the descriptions of the preceding exemplary embodiments, persons skilled in the art may understand that the methods according to the foregoing exemplary embodiments may be implemented by hardware only or by software and a hardware platform. However, in most cases, using software and a hardware platform are advantageous. Based on such an understanding, the technical solutions of the present disclosure essentially, or the part contributing to the existing technology may be implemented in a form of a software product. The computer software product may be stored in a storage medium (such as a ROM/RAM, a magnetic disk, or an optical disc) and includes several instructions for instructing a terminal device (which may be a mobile phone, a computer, a server, a network device, or the like) to perform the methods described in the exemplary embodiments.

### Exemplary Embodiment 2

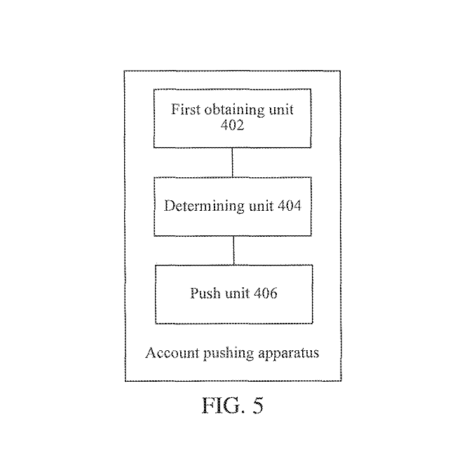

According to this exemplary embodiment, an account pushing apparatus for implementing the foregoing account pushing method is further provided, as shown in FIG. 5, including: a memory, a processor, and one or more functional modules stored in the memory and capable of running on the processor, the functional modules stored in the memory including:

1) a first obtaining unit 402, configured to obtain a set of accounts that are on a client running on a terminal that is logged in to by using a first account and that have an association relationship with the first account, and a current location of the terminal;

2) a determining unit 404, configured to determine, in a first public account according to at least a second public account, first operation information, and second operation information, a list of public accounts to be pushed to the client, the first public account being a public account operated in the location, the second public account being a public account operated by a second account in the set of accounts in the location, the first operation information being operation information of an operation performed on the first public account, and the second operation information being operation information of an operation performed on the second public account; and

3) a push unit 406, configured to push the list of public accounts to the first account used by the client for login.

In an implementation of this exemplary embodiment, the account pushing apparatus may be applied to an account pushing process of different types of applications, for example, a game application, a communications application, and a video application. In this exemplary embodiment, the public account may be, but is not limited to, a public social network entity, for example, an account used by a particular group on an information exchange platform for exchanging content such as words, pictures, audio, or videos, for example, a public account such as a service number, a subscription, or a corporate account.

Specifically, the client running on the terminal logs in by using the first account. The set of accounts that are on the client and that have an association relationship with the first account, and the current location of the terminal are obtained. The list of public accounts to be pushed to the client is determined in the first public account according to at least the second public account, the first operation information, and the second operation information, the first public account being the public account operated in the location, the second public account being the public account operated by the second account in the set of accounts in the location, the first operation information being the operation information of an operation performed on the first public account, and the second operation information being the operation information of an operation performed on the second public account. Therefore, a more associated public account is pushed to the first account used by the client for login, thereby improving pushing accuracy.

It should be noted that, in this exemplary embodiment, the set of accounts that have an association relationship with the first account, and the current location of the terminal are obtained, the client running on the terminal logging in by using the first account. The list of public accounts to be pushed to the client is determined in the first public account according to at least the second public account, the first operation information, and the second operation information, the first public account being the public account operated in the location, the second public account being the public account operated by the second account in the set of accounts in the location, the first operation information being the operation information of an operation performed on the first public account, and the second operation information being the operation information of an operation performed on the second public account. The list of public accounts is pushed to the first account used by the client for login. Therefore, the public account relatively associated with the first account used by the client running on the terminal is obtained based on the current location of the terminal, to obtain the list of public accounts whose locations and content and are both associated with the first account. That is, the pushed account satisfies the real requirement better by combining the public account operated in the current location of the terminal and the operation information of the operation, thereby improving a correlation between the pushed account and the account used by the client running on the terminal for login. An account is not blindly pushed according to distances, thereby ensuring the accuracy of account pushing, to overcome the problem in the existing technology that the accuracy of pushing the account according to distances is relatively low. In addition, for an operator or a publisher of an account, the utilization of an associated account may be greatly improved by accurately pushing the associated account to the account used by the client for login, thereby expanding a serving range of the associated account.

In an implementation of this exemplary embodiment, the set of accounts that have an association relationship with the first account may be, but is not limited to, user accounts used for exchanging content such as words, pictures, audio, and videos. The association relationship may include, but is not limited to, a member account (the second account) in the set of accounts is an account that is bound to the first account in advance, for example, one or more accounts in a friend list of the first account.

In some exemplary embodiments, the operation may include, but is not limited to, at least one of the following: a session sharing operation, a space sharing operation, an account association operation, a searching operation, or an account login operation. The account association operation may include, but is not limited to, a subscription operation, a following operation, or the like. In addition, in this exemplary embodiment, the operation information may include, but is not limited to, an operation type and an operation quantity corresponding to the operation type.

It should be noted that, in this exemplary embodiment, the foregoing different operations may or may not have different priorities. Different preset weights may be configured when the to-be-pushed list of public accounts is determined. This is not limited in this exemplary embodiment.

In an implementation of this exemplary embodiment, the determining, in a first public account according to at least a second public account, first operation information, and second operation information, a list of public accounts to be pushed to the client may be, but is not limited to, obtaining, from the first public account according to the first operation information, a target public account whose use frequency in the location is greater than a first predetermined threshold; and after searching the target public account for a public account matching the second public account, determining a correlation between the matching public account and the first account according to at least the second operation information, so as to obtain, according to the correlation, the list of public accounts for pushing.

It should be noted that, in this exemplary embodiment, the use frequency may be obtained by means of statistics collection by the server according to the public account operated by all accounts of the application client, or may be obtained in another manner. The target public account obtained according to the use frequency may be, but is not limited to, a superior public account obtained by analyzing a large amount of statistics data. That is, the superior public account is a public account that the public pay relatively much attention. Therefore, the superior public account is selected to serve as a candidate account (that is, the target public account) that is of the public account and that is used for pushing. A correlation between the superior public account and the first account is further determined by combining the second operation information and/or a time stamp, so as to accurately push the associated public account to the first account.

In an implementation of this exemplary embodiment, the list of public accounts may include, but is not limited to a group of public account sequences. An order of the sequences may be determined according to the correlation, or may be determined according to another factor.

In an implementation of this exemplary embodiment, the determining a correlation between the matching public account and the first account according to at least the second operation information may include, but is not limited to:

1) determining a first correlation between the matching public account and the first account according to an operation type indicated by the second operation information and an operation quantity corresponding to the operation type; and

2) obtaining a time stamp of the matching public account, to determine a second correlation between the matching public account and the first account.

A priority of the second correlation may be higher than a priority of the first correlation. That is, time validity comes first.

It should be noted that, in this exemplary embodiment, the server may obtain, according to the first correlation between the matching public account and the first account that is determined according to the second operation information, the list of public accounts for pushing; or may determine the second correlation between the matching public account and the first account by combining a time stamp of the matching public account and by using the time validity of the matching public account. Therefore, the public account associated with the first account obtained, and the list of public accounts for pushing is obtained, so that the pushed list of public accounts may satisfy the real requirement, thereby improving accuracy of account pushing.

In an implementation of this exemplary embodiment, when the public account matching the second public account is not found from the target public account, the list of public accounts may be determined in at least one of the following manner or in another manner:

1) obtaining a time stamp of the target public account, to determine a third correlation between the target public account and the first account, so as to determine the list of public accounts by using the third correlation; and

2) determining the list of public accounts according to use frequency.

It should be noted that, in this exemplary embodiment, when the public account matching the second public account is not found in the target public account, that is, when a friend account associated with the first account has not performed, in the location, any operation on the target public account (that is, a candidate account) obtained according to the first operation information, the third correlation between the target public account and the first account may be directly obtained by using the time stamp, to obtain, according to time validity of the target public account, the list of public accounts for pushing.

In an implementation of this exemplary embodiment, the obtaining the list of public accounts according to the correlations includes: obtaining first N public accounts according to values of the correlation, to obtain the list of public accounts. N is greater than or equal to 1. Therefore, the first N public accounts having a relatively large association are pushed to the first account according to the values of the correlations, so that the pushed public accounts further satisfy a requirement of a user.

In addition, in this exemplary embodiment, for a public account whose correlation cannot be obtained, an order, which is in the list of public accounts, of target public accounts that do not have the time stamp and that have not been operated by the second account in the set of accounts may be determined according to the use frequency. This is not limited in this exemplary embodiment.

In an implementation of this exemplary embodiment, the first obtaining unit may include:

1) a sixth obtaining module, configured to obtain a target location reported in real time by the terminal;

2) a second searching module, configured to search for a preset location matching the target location; and

3) a third determining module, configured to use the preset location as the current location of the terminal when the preset location matching the target location is found, where a distance between the matching preset location and the target location is less than a second predetermined threshold.

It should be noted that, in this exemplary embodiment, the terminal constantly moves in an environment. The client running on the terminal may detect a change of the location of the terminal in real time, and report the detected target location, so that the server compares the target location with a preset location pre-divided by a system. When the target location reported by the terminal matches the preset location (that is, the preset location matching the target location is found), the preset location is used as the current location of the terminal, so as to obtain an operated public account and corresponding operation information according to the current location of the terminal.

In an implementation of this exemplary embodiment, the first public account and the second public account may be, but is not limited to public accounts having a location tag. That is, in this exemplary embodiment, the public accounts having the location tag may be selected according to, but not limited to, registration information, service information, and the like of the public accounts. Further, the account pushing apparatus provided in this exemplary embodiment is performed on the public accounts having the location tag, to push the list of public accounts having the location tag to the first account of the client.

It is assumed that, as shown in Table 6, the first public account operated in the location includes ten public accounts, the operation that is indicated by the first operation information and that is performed on the first public account includes: a space sharing operation, a searching operation, and an account login operation. The corresponding operation quantities are shown in Table 6.

TABLE 6

| | First operation information | | |
|---|---|---|---|
| | Account login | Searching | Space sharing |
| First public account | operation | operation | operation |
| Public account ID-1 | 80,000 times | 90,000 times | 80,000 times |
| Public account ID-2 | 100,000 times | 80,000 times | 110,000 times |
| Public account ID-3 | 120,000 times | 90,000 times | 150,000 time |
| Public account ID-4 | 100,000 times | 120,000 times | 100,000 times |
| Public account ID-5 | 150,000 time | 110,000 times | 120,000 times |
| Public account ID-6 | 60,000 times | 100,000 times | 80,000 times |
| Public account ID-7 | 50,000 times | 120,000 times | 60,000 times |
| Public account ID-8 | 120,000 times | 100,000 times | 150,000 time |
| Public account ID-9 | 60,000 times | 150,000 times | 100,000 times |
| | Second operation information | | |
| Second public | Account login | Searching | Space sharing |
| account | operation | operation | operation |
| Public account ID-10 | 100,000 times | 80,000 times | 120,000 times |

Further, it is assumed that the second public account operated in the location includes five public accounts. The operation that is indicated by the second operation information and that is performed on the second public account includes: a space sharing operation, a searching operation, and an account login operation. The corresponding operation quantities are shown in Table 7. The slash represents that the operation is not performed.

TABLE 7

| | Second operation information | | |
|---|---|---|---|
| Second public | Account login | Searching | Space sharing |
| account | operation | operation | operation |
| Public account ID-1 | 10 times | | 6 times |
| Public account ID-3 | 8 times | 10 times | 12 times |
| Public account ID-8 | | 10 times | 12 times |
| Public account ID-10 | 10 times | 8 times | |
| Public account ID-11 | 10 times | | 12 times |

The list of public accounts to be pushed to the client is determined in the first public account according to at least the first operation information, the second operation information, and the second public account.

According to this exemplary embodiment provided in this application, the pushed account satisfies the real requirement better by combining the public account operated in the current location of the terminal and the operation information of the operation, thereby improving a correlation between the pushed account and the account used by the client running on the terminal for login. An account is not blindly pushed according to distances, thereby ensuring the accuracy of account pushing, to overcome the problem in the existing technology that the accuracy of pushing the account according to distances is relatively low. In addition, for an operator or a publisher of an account, the utilization of an associated account may be greatly improved by accurately pushing the associated account to the account used by the client for login, thereby expanding a serving range of the associated account.

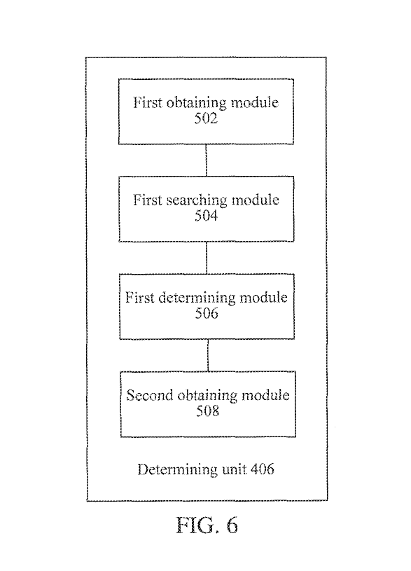

In some exemplary embodiments, as shown in FIG. 6, the determining unit 406 may include:

1) a first obtaining module 502, configured to obtain, from the first public account according to the first operation information, a target public account whose use frequency in the location is greater than a first predetermined threshold;

2) a first searching module 504, configured to search the target public account for a public account matching the second public account;

3) a first determining module 506, configured to determine a correlation between the matching public account and the first account according to at least the second operation information when the matching public account is found; and

4) a second obtaining module 508, configured to obtain the list of public accounts according to the correlation.

In an implementation of this exemplary embodiment, the first operation information may include, but is not limited to, an operation type of an operation performed on the first public account in the current location of the terminal and an operation quantity corresponding to the operation type. The operation includes at least one of the following: a session sharing operation, a space sharing operation, an account association operation, a searching operation, or an account login operation.

It should be noted that, in this exemplary embodiment, the foregoing different operations may or have different priorities or a same priority. Different preset weights may be configured when the to-be-pushed list of public accounts is determined, to obtain a corresponding correlation between the first public account and the first account. This is not limited in this exemplary embodiment.

In an implementation of this exemplary embodiment, before the obtaining, from the first public account according to the first operation information, a target public account whose use frequency in the location is greater than a first predetermined threshold, the method further includes: obtaining, according to the first operation information, an operation type of an operation performed on each first public account and an operation quantity corresponding to the operation type; and obtaining use frequency of each first public account in the location according to a second weight corresponding to the operation type and the operation quantity corresponding to the operation type.

In an implementation of this exemplary embodiment, the first public account operated in the location may include, but is not limited to, one or more public accounts and one or more public accounts of the second public account operated in the location.

For details, refer to the example shown in Table 6 for description. It is assumed that the operation that is indicated by the first operation information and that is performed on the first public account includes: an account login operation, a searching operation, and a space sharing operation, and corresponding weights are 0.2, 0.3, and 0.5. The corresponding use frequency may be shown in Table 8.

TABLE 8

| First public account | Use frequency |
|---|---|
| Public account ID-1 | 8.3 |
| Public account ID-2 | 9.9 |
| Public account ID-3 | 12.6 |
| Public account ID-4 | 10.6 |
| Public account ID-5 | 12.3 |
| Public account ID-6 | 8.2 |
| Public account ID-7 | 7.6 |
| Public account ID-8 | 12.9 |
| Public account ID-9 | 10.7 |
| Public account ID-10 | 10.4 |

It is assumed that the first predetermined threshold is 10. The target public account sequentially includes: public account ID-8, public account ID-3, public account ID-5, public account ID-9, public account ID-4, and public account ID-10.

Further, the public account matching the second public account in the target public account is searched with reference to Table 7. It may be obtained through comparison that the matching public account includes: public account ID-8, public account ID-3, and public account ID-10. Then, correlations between the matching public accounts and the first account are separately determined according to the second operation information, to obtain the list of public accounts according to the correlations. Therefore, the public account associated with the first account is pushed to the first account of the client, to ensure accuracy of public account pushing, and improve the user experience.

It should be noted that, in this exemplary embodiment, the list of public accounts may include, but is not limited to, the matching public account, or may include another public account obtained according to another rule. The another rule may include, but is not limited to, time validity and use frequency. For example, it is assumed that it is preset that the list of public accounts may include five public accounts. In the foregoing example, the public account includes only three public accounts. Moreover, two public accounts may further be obtained according to the use frequency to serve as public accounts on the list of public accounts, for example, public account ID-5 and public account ID-9.

According to this exemplary embodiment provided in this application, the target public account whose use frequency is greater than the first predetermined threshold may be selected from the first public account according to the first operation information, and then, the target public account is searched for the public account matching the second public account, thereby determining the correlation between the public account and the first account according to at least the second operation information, to obtain the list of public accounts according to the correlation. That is, the public account associated with the first account may be obtained by using the public account operated in the current location of the terminal and the operation information of the operation, thereby improving the correlation between a pushed account and an account used by the client running on the terminal for login, so that the pushed account satisfies a real requirement better, thereby further ensuring accuracy of account pushing. In addition, because the pushed account is accurate, the utilization of the pushed account is further improved.

In some exemplary embodiments, the first determining module may include:

1) a first obtaining submodule, configured to obtain, according to the second operation information, an operation type of an operation performed on the matching public account and an operation quantity corresponding to the operation type; and

2) a second obtaining submodule, configured to separately obtain a first correlation between the matching public account and the first account according to a first weight corresponding to the operation type.

In an implementation of this exemplary embodiment, the a first correlation between the matching public account and the first account according to a first weight corresponding to the operation type may include, but is not limited to: obtaining a weighted average between each matching public account and an operation quantity corresponding to the operation type, to serve as the first correlation between the matching public account and the first account.

A detailed description is given with reference to the following example. The second obtaining submodule obtains the first correlation between the matching public account and the first account according to the first weight corresponding to the operation type and by using the following formula:

$${S}_{j} = {\sum }_{i = 1}^{n} {a}_{i} {P}_{i} \qquad ( 3 )$$

where Sⱼ represents the first correlation between the j^{th} matching public account and the first account, Pᵢ represents an operation quantity corresponding to the i^{th} operation type, aᵢ represents a first weight corresponding to the i^{th} operation type, and n represents n operation types.

A description is given with reference to the example shown in Table 7. It is assumed that, with reference to Table 7, the public account that is found in the target public account and that matches the second public account includes: public account ID-8, public account ID-3, and public account ID-10. The operation that is indicated by the second operation information and that is performed on the second public account includes: an account login operation, a searching operation, and a space sharing operation, and corresponding weights are 0.2, 0.2, and 0.6. The corresponding first correlation may be shown in Table 9.

TABLE 9

| Matching public account | First correlation |
|---|---|
| Public account ID-3 | 8.4 |
| Public account ID-8 | 9.2 |
| Public account ID-10 | 3.6 |

That is, in this exemplary embodiment, public account ID-8, public account ID-3, and public account ID-10 may be sequentially pushed according to the foregoing first correlations. That is, in this exemplary embodiment, a public account that has been operated by a friend account of the first account is preferably selected from the list of public accounts. For example, a public account that is relatively frequently shared by the friend account of the first account and a public account that is followed by the friend account of the first account are preferably pushed. Different operations have different priorities and correspond to different first weights. An operation with a higher priority corresponds to a larger first weight. For example, a priority of the account login operation is lower than a priority of the space sharing operation, and corresponding weights are 0.2 and 0.6.

It should be noted that, in this exemplary embodiment, the list of public accounts may include, but is not limited to, the matching public account having the first correlation, or may include another public account obtained according to another rule. The another rule may include, but is not limited to, time validity and use frequency. For example, it is assumed that it is preset that the list of public accounts may include five public accounts. In this exemplary embodiment, in addition to three public accounts having the first correlation, the list of public accounts may further obtain two additional public accounts according to use frequency of the public accounts, to obtain all public accounts in the list of public accounts. Herein, the public accounts having the first correlation are sorted according to correlations, and the rest are sorted according to the use frequency. For example, according to the foregoing example, the list of public accounts that is obtained herein and that is pushed to the first account in the location may sequentially include: public account ID-8, public account ID-3, public account ID-10, public account ID-5, and public account ID-9.

According to this exemplary embodiment provided in this application, the operation type of an operation performed on the matching public account and the operation quantity corresponding to the operation type are obtained according to the second operation information, to obtain the first correlation between the matching public account and the first account according to the first weight corresponding to the operation type, thereby ensuring that the public account having a high association with the first account is pushed to a first client, to improve use efficiency of the public account.

In some exemplary embodiments, the first determining module may include:

1) a third obtaining submodule, configured to obtain a first time stamp of the matching public account; and

2) a fourth obtaining submodule, configured to obtain a second correlation between the matching public account and the first account according to the first time stamp, where a priority of the second correlation is higher than a priority of the first correlation.

In an implementation of this exemplary embodiment, the correlation between the public account and the first account may be obtained according to a time indicated by the time stamp of the public account, which is not limited in this exemplary embodiment. That is, the to-be-pushed list of public accounts is determined according to time validity. For example, during mealtime, a public account about food is preferably pushed. For example, during holidays, a public account about weather or transport is preferably pushed. The foregoing is merely an example, which is not limited in this exemplary embodiment.

For example, it is assumed that a current time is 19:00 on Saturday, and the first time stamp of the matching public account obtained in the foregoing example is shown in Table 10.

TABLE 10

| Matching public account | First time stamp |
|---|---|
| Public account ID-3 (a food public account) | 11:30-12:30 |
| | 17:00-19:00 |
| Public account ID-8 (a weather public account) | 9:00 |
| | 18:00 |
| Public account ID-10 (an airline public account) | Holidays 10:00 |

With reference to Table 10, it may be obtained, by comparing time, public account ID-3 (the food public account) and public account ID-10 (the airline public account) that have the second correlation. Further, with reference to the first correlation based on the second correlation, the list of public accounts: public account ID-3 (the food public account), public account ID-10 (the airline public account), and public account ID-8 (the weather public account) may be pushed to the first account logging in to the terminal in the location.

According to this exemplary embodiment provided in this application, the first time stamp of the matching public account is combined, to obtain the second correlation between the matching public account and the first account according to the first time stamp. The priority of the second correlation is higher than the first correlation. The to-be-pushed list of public accounts is determined with reference to the second correlation and the first correlation. That is, a public account associated with the first account is obtained from different dimensions, thereby obtaining the list of public accounts satisfying a requirement in multiple dimensions, to ensure accuracy of the pushed account, and further improve the use efficiency of the pushed account.

In some exemplary embodiments, the apparatus may further include:

1) a third obtaining module, configured to: after the target public account is searched for a public account matching the second public account, obtain a second time stamp of the target public account when the matching public account is not found; and

2) a second determining module, configured to determine a third correlation between the target public account and the first account according to the second time stamp.

In an implementation of this exemplary embodiment, when the public account matching the second public account is not found in the target public account, the third correlation between the target public account and the first account may be directly obtained by using the second time stamp

A detailed description is given with reference to the example shown in Table 6. Second time stamps of the ten public accounts shown in Table 6 may be directly obtained, and further, correlations between the ten public accounts and the first account are determined according to time validity of the time stamps. For a specific process, refer to the foregoing example, and details are not described in this exemplary embodiment again.

According to this exemplary embodiment provided in this application, the second time stamp of the target public account is obtained, to determine the third correlation between the target public account and the first account according to the second time stamp. In this way, the public account associated with the first account may be obtained from a time dimension when the public account matching the second public account is not found, thereby ensuring that an associated account is accurately pushed to the first account in the terminal in the location, to improve the accuracy of the pushed account, so that the pushed account satisfies the real requirement better.

In some exemplary embodiments, the apparatus may further include:

1) a fourth obtaining module, configured to before the target public account whose use frequency in the location is greater than the first predetermined threshold is obtained from the first public account according to the first operation information, obtain, according to the first operation information, an operation type of an operation performed on each first public account and an operation quantity corresponding to the operation type; and

2) a fifth obtaining module, configured to separately obtain use frequency of each first public account in the location according to a second weight corresponding to the operation type and the operation quantity corresponding to the operation type.

In an implementation of this exemplary embodiment, the operation indicated by the first operation information and the operation indicated by the second operation information may be the same or may be different. When the indicated operations are the same, the first weight and the second weight may be set to different values or a same value according to different application scenarios, which is not limited in this exemplary embodiment.

For details, refer to the example shown in Table 6 for description. It is assumed that the operation that is indicated by the first operation information and that is performed on the first public account includes: an account login operation, a searching operation, and a space sharing operation, and corresponding weights are 0.2, 0.3, and 0.5.

Further, the use frequency of the first public account in the location may be obtained in the following manner according to the following formula or in another manner according to the second weight corresponding to the operation type and the operation quantity corresponding to the operation type:

$${P}_{t} = {\sum }_{i = 1}^{m} {b}_{i} {Q}_{i} \qquad ( 4 )$$

where Pₜ represents use frequency of the t^{th} first public account in the location, Qᵢ represents an operation quantity corresponding to the i^{th} operation type, bᵢ represents the second weight corresponding to the i^{th} operation type, and m represents m operation types.

In this exemplary embodiment, the use frequency of the first public account in the location shown in Table 8 may be obtained.

According to this exemplary embodiment provided in this application, the operation type of the operation performed on each first public account and the operation quantity corresponding to the operation type are obtained according to the first operation information; the use frequency of each first public account in the location is obtained according to the second weight corresponding to the operation type and the operation quantity corresponding to the operation type. In this way, the target public account is obtained from a large number of first public accounts, to narrow down the range of to-be-pushed public accounts, and improve the pushing efficiency. In addition, if the target public account whose use frequency is greater than the first predetermined threshold is selected from the first public account, a public account with relatively high quality, that is, the public account followed by a relative large number of users, may be selected, so that the user efficiency of the pushed public account is improved.

In some exemplary embodiments, the first obtaining module 402 may include:

1) a sixth obtaining module, configured to obtain a target location reported in real time by the terminal;

2) a second searching module, configured to search for a preset location matching the target location; and

3) a third determining module, configured to use the preset location as the current location of the terminal when the preset location matching the target location is found, where a distance between the matching preset location and the target location is less than a second predetermined threshold.

It should be noted that, in this exemplary embodiment, the terminal constantly moves in an environment. The client running on the terminal may detect a change of the location of the terminal in real time, and report the detected target location, so that the server compares the target location with a preset location pre-divided by a system. When the target location reported by the terminal matches the preset location (that is, the preset location matching the target location is found), the preset location is used as the current location of the terminal, so as to obtain an operated public account and corresponding operation information according to the current location of the terminal.

A detailed description is given with referent to the following example. It is assumed that it is obtained that the location reported by the terminal is A. It is obtained through searching that the location A is relatively close to a preset location A′ (a distance between the location A and the preset location A′ is less than the second predetermined threshold), and in this exemplary embodiment, the preset location A′ may or may not be used as the current location of the terminal. Therefore, public account operated in the preset location A′ and corresponding operation information are obtained.

According to this exemplary embodiment provided in this application, the target location reported by the terminal obtained in real time, and is compared with the preset location, to obtain the current location of the terminal used for obtaining the public account. Therefore, the current location of the terminal on which the client runs is passively obtained. The associated public account may be pushed in real time to the first account used by the client for login, without actively sending, on the client, a push request carrying location information of the current location of the terminal, thereby simplifying an account pushing operation, and improving the efficiency of account pushing.

### Exemplary Embodiment 3

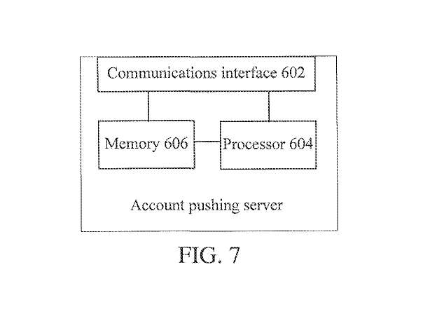

According to this exemplary embodiment, an account pushing server may be further provided. As shown in FIG. 7, the server includes:

1) a communications interface 602, configured to obtain a set of accounts that are on a client running on a terminal that is logged in to by using a first account and that have an association relationship with the first account, and a current location of the terminal;

2) a processor 604, connected to the communications interface 602, and configured to determine, in a first public account according to at least a second public account, first operation information, and second operation information, a list of public accounts to be pushed to the client, the first public account being a public account operated in the location, the second public account being a public account operated by a second account in the set of accounts in the location, the first operation information being operation information of an operation performed on the first public account, and the second operation information being operation information of an operation performed on the second public account; and

3) a memory 606, connected to the communications interface 602 and the processor 604, and configured to store the first operation information, the second operation information, the second public account, the first public account, and the list of public accounts.

In an implementation of this exemplary embodiment, for a specific example in this exemplary embodiment, refer to the examples described in Exemplary embodiment 1 and Exemplary embodiment 2, and details are not described in this exemplary embodiment again.

### Exemplary Embodiment 4

This exemplary embodiment further provides a computer storage medium, the computer storage medium storing computer executable instructions, and the computer executable instructions being used for performing the foregoing account pushing method. In this exemplary embodiment, the foregoing computer storage medium may be located in at least one of multiple network devices in a computer network.

In an implementation of this exemplary embodiment, in this exemplary embodiment, the computer storage medium may be configured to store program code used for performing the following steps:

S1. Obtain a set of accounts that are on a client running on a terminal that is logged in to by using a first account and that have an association relationship with the first account, and a current location of the terminal.

S2. Determine, in a first public account according to at least a second public account, first operation information, and second operation information, a list of public accounts to be pushed to the client, the first public account being a public account operated in the location, the second public account being a public account operated by a second account in the set of accounts in the location, the first operation information being operation information of an operation performed on the first public account, and the second operation information being operation information of an operation performed on the second public account.

S3. Push the list of public accounts to the first account used by the client for login.

In an implementation of this exemplary embodiment, the foregoing computer storage medium may include, but is not limited to, any medium that may store program code, such as a USB flash drive, a read-only memory (ROM), a random access memory (RAM), a removable hard disk, a magnetic disk, or an optical disc.

In an implementation of this exemplary embodiment, for a specific example in this exemplary embodiment, refer to the examples described in Exemplary embodiment 1 and Exemplary embodiment 2, and details are not described in this exemplary embodiment again.

The sequence numbers of the preceding exemplary embodiments are merely for a description purpose but do not indicate the preference of the exemplary embodiments.

When the integrated unit in the foregoing exemplary embodiment is implemented in a form of a software functional module and sold or used as an independent product, the integrated unit may be stored in the foregoing computer-readable storage medium. Based on such an understanding, the technical solutions of the present disclosure essentially, or the part contributing to the existing technology, or all or some of the technical solutions may be implemented in a form of a software product. The computer software product is stored in a storage medium and includes several instructions for instructing one or more computer devices (which may be a personal computer, a server, a network device, or the like) to perform all or some of the steps of the methods described in the exemplary embodiments.

In the foregoing exemplary embodiments, descriptions of the exemplary embodiments have different emphases, and as for parts that are not described in detail in one exemplary embodiment, reference may be made to the relevant descriptions of the other exemplary embodiments.

In the several exemplary embodiments provided in this application, it should be understood that the disclosed client may be implemented in other manners. The described apparatus exemplary embodiments are merely exemplary. For example, the unit division is merely logical function division and may be other division during actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in an electronic form or other forms.

The units described as separate parts may or may not be physically separate, and the parts displayed as units may or may not be physical units, may be located in one location, or may be distributed on a plurality of network units. Some or all of the units may be selected to achieve the objectives of the solutions of the exemplary embodiments.

In addition, functional units in the exemplary embodiments may be integrated into one processing unit, or each of the units may exist alone physically, or two or more units may be integrated into one unit. The integrated unit may be implemented in a form of hardware, or may be implemented in a form of a software functional unit.

The above descriptions are merely preferred exemplary embodiments, and it should be noted that, a person of ordinary skill in the art may make various improvements and refinements without departing from the spirit of the present disclosure. All such modifications and refinements shall fall within the protection scope of the present disclosure and the appended claims.

In the exemplary embodiments, a set of accounts that have an association relationship with the first account, and a current location of the terminal are obtained, and a client running on a terminal is logged in to by using a first account. A list of public accounts to be pushed to the client is determined in a first public account according to at least a second public account, first operation information, and second operation information, the first public account being a public account operated in the location, the second public account being a public account operated by a second account in the set of accounts in the location, the first operation information being operation information of an operation performed on the first public account, and the second operation information being operation information of an operation performed on the second public account. Therefore, the public account relatively associated with the first account used by the client running on the terminal is obtained based on the current location of the terminal, to obtain the list of public accounts whose locations and content and are both associated with the first account. That is, the pushed account satisfies the real requirement better by combining the public account operated in the current location of the terminal and the operation information of the operation, thereby improving a correlation between the pushed account and the account used by the client running on the terminal for login. An account is not blindly pushed according to distances, thereby ensuring the accuracy of account pushing, to overcome the problem in the existing technology that the accuracy of pushing the account according to distances is relatively low.

What is claimed is:

1. A method comprising:
obtaining a current location of a terminal, and a set of accounts that are on a client running on the terminal that is logged into by a first account and that have an association relationship with the first account;
obtaining a list of target public accounts that are operated in the current location;
selecting, from the list of target public accounts, one or more push accounts based on the set of accounts that are obtained; and
pushing the one or more push accounts to the first account.

2. The method of claim 1, wherein the association relationship comprises a friend relationship, a follow relationship, a group relationship, and a sharing relationship.

3. The method of claim 1, wherein the set of accounts includes both first private accounts that have a friend relationship with the first account, and first public accounts that are being followed by the first account in a follow relationship.

4. The method of claim 1, wherein the set of accounts includes first public accounts with which the first account has performed an operation, and
target public accounts that correspond to the first public accounts are selected as the one or more push accounts.

5. The method of claim 4, wherein the operation is a follow operation.

6. The method of claim 4, wherein the set of accounts includes first private accounts with which the first account has a friendship relationship, and
target public accounts with which one or more of the first private accounts have performed an operation are selected as the one or more push accounts.

7. The method of claim 6, wherein the operation is a follow operation.

8. The method of claim 1, wherein the one or more push accounts are selected from the list of target accounts based on a frequency of interaction between the set of accounts and the target accounts.

9. The method of claim 1, wherein the one or more push accounts are selected from the list of target accounts based on a current time and on a frequency of interaction between the set of accounts and the target accounts.

10. The method of claim 1, further comprising:
sequencing the one or more push accounts in priority order, based on a frequency of interaction between the set of accounts and the target accounts and the current time when in operation of one or more of the target accounts.

11. An apparatus comprising:
at least one memory configured to store computer program code; and
at least one processor configured to access the at least one memory and operate according to the computer program code, the computer program code including:
first obtaining code configured to cause at least one of the at least one processor to obtain current location of a terminal, and a set of accounts that are on a client running on the terminal that is logged into by a first account and that have an association relationship with the first account;
second obtaining code configured to cause at least one of the at least one processor to obtain a list of target public accounts that are operated in the current location;
selection code configured to cause at least one of the at least one processor to select, from the list of target public accounts, one or more push accounts based on the set of accounts that are obtained; and
push code configured to cause at least one of the at least one processor to push the one or more push accounts to the first account.

12. The apparatus of claim 11, wherein the association relationship comprises a friend relationship, a follow relationship, a group relationship, and a sharing relationship.

13. The apparatus of claim 11, wherein the set of accounts includes both first private accounts that have a friend relationship with the first account, and first public accounts that are being followed by the first account in a follow relationship.

14. The apparatus of claim 11, wherein the set of accounts includes first public accounts with which the first account has performed an operation, and
the selection code is configured to cause the at least one of the at least one processor to select, as the one or more push accounts, target public accounts that correspond to the first public accounts.

15. The apparatus of claim 14, wherein the operation is a follow operation.

16. The apparatus of claim 14, wherein the set of accounts includes first private accounts with which the first account has a friendship relationship, and
the selection code is configured to cause the at least one of the at least one processor to select target public accounts with which one or more of the first private accounts have performed an operation, as the one or more push accounts.

17. The apparatus of claim 16, wherein the operation is a follow operation.

18. The apparatus of claim 11, wherein the selection code is configured to cause the at least one of the at least one processor to select the one or more push accounts from the list of target accounts based on a frequency of interaction between the set of accounts and the target accounts.

19. The apparatus of claim 11, wherein the selection code is configured to cause the at least one of the at least one processor to select the one or more push accounts from the list of target accounts based on a current time and on a frequency of interaction between the set of accounts and the target accounts.

20. The apparatus of claim 11, wherein the selection code is configured to cause the at least one of the at least one processor to select the one or more push accounts from the list of target accounts based on a frequency of interaction between the set of accounts and the target accounts.
